(19) United States
(12) Patent Application Publication
(10) Pub. No.: US 2026/0085964 A1
(43) Pub. Date: Mar. 26, 2026

(54) METHOD FOR DETECTING A MEASUREMENT OBJECT USING A SENSOR WITH SELF-MONITORING OF THE MEASURING POSITION, AND SENSOR, IN PARTICULAR ADAPTED FOR CARRYING OUT SUCH A METHOD

(71) Applicant: RECHNER Industrie-Elektronik GmbH, Lampertheim (DE)

(72) Inventors: Eduard BISCHLER, Lampertheim (DE); Armin KOHLER, Lampertheim (DE); Stefan GEBHARDT, Lampertheim (DE)

(21) Appl. No.: 19/332,734

(22) Filed: Sep. 18, 2025

(30) Foreign Application Priority Data
Sep. 20, 2024 (EP) 24201561.8

(51) Int. Cl. G01F 25/20; G01D 5/24; G01F 1/58; G01F 1/60; G01M 3/16; G08B 7/06; G08B 21/18

(52) U.S. Cl. CPC G01F 25/20; G01D 5/2405; G01F 1/584; G01F 1/60; G01M 3/16; G08B 7/06; G08B 21/182

(57) ABSTRACT

A method for detecting a measurement object in a measurement arrangement by a sensor. The sensor includes measurement electronics with an active surface, which has a measurement electrode and a counter electrode, and with an evaluation unit. The method includes generating a spatial measuring field, determining a calibration value, attaching the sensor to a surface of the measurement arrangement for measuring in a measuring position, determining a setting value in the measuring position in the absence of a measurement object within the measuring field, specifying a threshold value, which is defined by a value lying between the calibration value and the setting value, activating a measurement process for detecting the measurement object in the measurement position and capacitively detecting a measurement signal, a warning signal being output if the measurement value corresponding to the measurement signal is less than or equal to the defined threshold value.

### RELATED APPLICATION

This application claims priority to EP application no. 24201561.8 filed Sep. 20, 2024, the entire disclosure of which is incorporated herein by reference.

### FIELD

The present invention relates to a method for detecting a measurement object in a measurement arrangement using a sensor and to a sensor for detecting a measurement object. The sensor has measurement electronics with an active surface, which has at least one measurement electrode and at least one counter electrode, and with an evaluation unit for evaluating a measurement signal detected by the at least one measurement electrode. The sensor is set up in particular for the capacitive detection of measurement signals for detecting the measurement object within the measurement field of the sensor. The measurement object to be detected can, in particular, be a product whose level is to be determined in a vessel, or which has escaped from a leak in a vessel.

### BACKGROUND

Sensors, in particular proximity sensors, are often used when it comes to detecting, in particular capacitive detecting, of a measurement object within a predetermined measurement volume. Such sensors detect measurement objects that are located in their measurement field by using the interaction of the measurement object with an alternating electric field generated by an electrode of the sensor. This results in a change in capacitance, which is caused by the presence of the measurement object in the alternating field depending on the respective permittivity value εᵣ of the measurement object.

For example, measurement methods based on capacitive detection of measurement signals using corresponding sensors to detect a filling level are often used for capacitive filling level measurements in containers. For example, a sensor can be mounted on a dielectric side wall or bottom wall of a vessel in order to detect a filling level in the vessel behind the wall. Furthermore, such measuring methods and such sensors are used, for example, to detect a leakage from a vessel, whereby the sensors used for this purpose are also referred to as so-called LEAK sensors. For example, a sensor can be mounted at a distance in front of a bottom surface at a defined distance and assume an intended measuring position in order to detect a leakage from the vessel by detecting filling material on the bottom surface. If there is an unintentional and unwanted change in the position of the sensor such that it is no longer in the intended measuring position, the measuring signal detected by the sensor also changes. If this change in the installation position of the sensor is not detected, this can lead to the detected measurement signal being misinterpreted, e.g. interpreted as the absence of filling material.

### SUMMARY

Against the aforementioned technical background, it is an object of the present invention to provide a further method for detecting a measurement object using a sensor and a sensor for detecting a measurement object, in particular by means of which the detection of a measurement object and a sensor performing in particular a method in this respect are improved, in particular improved in such a way that self-monitoring of the measurement position of the sensor takes place and a deviation from the intended measurement position of the sensor can be determined immediately. Such a deviation from the measuring position can be caused, for example, by the sensor slipping or tilting or by force being applied to the sensor.

The aforementioned object is solved by the features of the independent claims and is further developed and refined by the additional features of the respective subclaims.

Accordingly, to solve the object, the invention proposes a method for detecting a measurement object in a measurement arrangement using a sensor, in particular for capacitively detecting measurement signals for detecting a measurement object within a spatial measurement field of a sensor. The sensor has measurement electronics with an active surface, which has at least one measurement electrode and at least one counter electrode, and with an evaluation unit for evaluating a measurement signal detected by the at least one measurement electrode. The method comprises the following steps:
generating of a spatial measuring field by the measurement electronics of the sensor, the measuring field extending essentially transversely to the active surface and starting from the active surface,
determining a calibration value by capacitively detecting and evaluating a first measurement signal by means of the measurement electronics of the sensor, namely before attaching the sensor to a surface of a measurement arrangement for measuring in a measurement position, and storing the calibration value in the measurement electronics of the sensor,
attaching the sensor to the surface of the measurement arrangement for measuring in the measuring position in which a component of the measurement arrangement is located within the measuring field of the sensor,
determining a setting value by capacitively detecting and evaluating a second measurement signal by means of the measurement electronics of the sensor when the sensor is in the measurement position and when there is no measurement object within the measurement field of the sensor, and storing the setting value in the measurement electronics of the sensor, the setting value being greater than the calibration value,
specifying a threshold value by the measurement electronics in such a way that it is defined by a value between the calibration value and the setting value,
activating a measuring process for detecting the measurement object within the measurement field when the sensor is in the measurement position,
capacitively detecting and evaluating a third measurement signal by means of the measurement electronics of the sensor and
in the event that the detected third measurement signal evaluated by the measurement electronics corresponds to a measurement value which is less than the defined threshold value or equal to the defined threshold value, outputting a warning signal.

The method according to the invention is thus characterized in particular by the fact that a calibration value and, in addition, a setting value are determined. This means that before the measurement process for detecting a measurement object takes place, two different reference values are first determined, of which a first reference value or the calibration value relates to a first state of the sensor, in which the sensor is not in the intended measurement position, and a second reference value or the setting value relates to a second state of the sensor, in which the sensor is in the intended measurement position. The measuring position of the sensor corresponds to the position of the sensor that the sensor assumes after it has been properly attached to the surface of the measurement arrangement. Determining these two reference values serves in particular to check or monitor during the measuring process for detecting the measurement object whether the sensor is still in its measuring position or whether the sensor has left its intended measuring position and an mounting error or installation error has occurred. In particular, the measurement object can be a filling material, e.g. a liquid or a bulk material. In particular, the method can be a measuring method for measuring a filling level in a vessel or for detecting a leakage from a vessel. In the context of the invention, the measurement arrangement refers in particular to the entirety of the components required to implement the method, and thus the sensor and the object to be examined with regard to the measurement object, e.g. a vessel filled with filling material or a surface with filling material on it as a result of a leakage.

The determined calibration value corresponds to a measured value of the sensor that has been determined as part of a capacitive detection of a first measurement signal in a state of the sensor in which the sensor is not in the measurement position, but is exposed to an atmosphere or environment that is also essentially present during the measurement process, as is usual for calibration measurements. In particular, this atmosphere is air, but can also be vacuum in certain applications. After the calibration value has been determined and stored based on the first measurement signal detected, the sensor is attached to a surface of a measurement arrangement, in particular detachably attached, e.g. by means of a correspondingly designed holding device, in order to carry out measurements in its measurement position. The measurement arrangement can, for example, comprise a vessel, e.g. a container or a tub, to the surface of which the sensor is attached. The surface of the measurement arrangement can be, for example, a wall surface or a bottom surface of the vessel, but also a bottom surface of a room. The sensor is attached to the surface of the measurement arrangement in such a way that it is in a measuring position in which a component of the measurement arrangement is located within the measuring field of the sensor. This component of the measurement arrangement is in particular dielectric or conductive and can, for example, comprise the surface of the measurement arrangement to which the sensor is attached. If the sensor is in the measuring position, the setting value is determined. The setting value corresponds to a reference value in relation to the measuring position of the sensor, whereby no measurement object is located within the measuring field of the sensor. In other words, the setting value corresponds to a measured value of the sensor that has been determined as part of a capacitive detection of a second measurement signal in a state of the sensor in which the sensor is in the measurement position, namely in the absence of any measurement object within the measurement field. The setting value is greater than the calibration value due to an influencing variable caused by the component of the measurement arrangement located within the measuring field. This means that the component of the measurement arrangement is located within the measuring field due to the installation position of the sensor and causes a positive change in the sensor signals or the measured values. The determined setting value is stored in the sensor's measurement electronics, which then defines a value between the calibration value and the setting value as the threshold value. In particular, the threshold value is determined as a function of the difference between the setting value and the calibration value.

When the sensor is in the measurement position, a measurement process is activated to detect the measurement object so that a third measurement signal is capacitively detected within the measurement field and evaluated accordingly. In particular, capacitive detection takes place at regular intervals or continuously in order to quickly detect changes in the measured value. The measured value determined in each case is then compared with the defined threshold value. If it is determined that the evaluated detected third measurement signal corresponds to a measurement value that is less than the defined threshold value or equal to the defined threshold value, a warning signal is issued, in particular at the instigation of the measurement electronics. The warning signal indicates that the sensor is currently not or no longer in its measuring position or its correct mounting position, in particular that it has moved away from this, e.g. has become detached. The warning signal is therefore interpreted as a current installation error or mounting error of the sensor. The method according to the invention therefore makes it possible to detect an installation error as quickly and easily as possible and to avoid misinterpretation of measurement data.

If, on the other hand, it is determined that the evaluated detected third measurement signal corresponds to a measurement value that is greater than the determined setting value, this measurement result is interpreted by the measurement electronics as the presence of the measurement object within the measurement field and the measurement object is therefore detected. In particular, the detected third measurement signal is output in the form of a leakage measurement signal or a filling level measurement signal, e.g. using a display device included in the sensor. In the event that the measured value based on the detected third measurement signal is greater than the defined threshold value and less than the determined setting value or equal to the determined setting value, this measurement result is interpreted by the measurement electronics as a missing presence of the measurement object within the measurement field and evaluated as a currently non-existent installation error of the sensor. The value range between the setting value and the threshold value can therefore be regarded as a (fault) tolerance range, for example.

The capacitive detection of the first, second and third measurement signals can also comprise a capacitive detection of a respective plurality of first, second and third measurement signals, whereby the threshold value is determined based on the plurality of detected first and second measurement signals, e.g. by determining a correspondingly averaged calibration value and a correspondingly averaged setting value. Alternatively, a plurality of threshold values can be determined based on the plurality of detected first and second measurement signals.

Furthermore, the present invention proposes a sensor, in particular a proximity sensor, for detecting a measurement object in a measurement arrangement, which is set up in particular for carrying out the method described above. The sensor has measurement electronics for generating a spatial measurement field and for detecting a measurement object within the measurement field. The measurement electronics comprise an active surface, which has at least one measuring electrode and at least one counter electrode, with the measuring field extending essentially transversely to the active surface and starting from the active surface. In addition, the measurement electronics comprises an evaluation unit for evaluating a measurement signal detected by the at least one measuring electrode. The sensor can be attached to a surface of a measurement arrangement for measuring in a measuring position in which a component of the measurement arrangement is located within the measuring field of the sensor. For example, the sensor can have a holding device by means of which it can be detachably attached to the surface of the measurement arrangement. A calibration value can be stored or is already stored in the measurement electronics of the sensor, which is based on a first measurement signal that was recorded when the sensor was not in the measurement position. Furthermore, a setting value can also be stored or has already been stored in the measurement electronics, which is based on a second measurement signal that was recorded when the sensor was in the measurement position and there was no measurement object within the measurement field. The setting value is greater than the calibration value. The measurement electronics are set up to specify a threshold value in such a way that it is defined by a value between the calibration value and the setting value, in particular as a function of a difference between the setting value and the calibration value. The sensor is set up to start a measurement process for detecting the measurement object within the measurement field when the sensor is in the measurement position and to capacitively detect and evaluate a third measurement signal by means of the measurement electronics. The sensor is also set up to output a warning signal in the event that the detected third measurement signal evaluated by the measurement electronics corresponds to a measurement value that is less than or equal to the defined threshold value. For this purpose, the sensor can, for example, have a display device for the visual display of the warning signal and/or a device for emitting an acoustic warning signal and/or a separate sensor output via which it can emit the warning signal, e.g. as a digital signal.

In addition to the at least one measuring electrode, the active surface of the sensor can also comprise one or more further measuring electrodes, which, taken together, are referred to as a plurality of measuring electrodes in the context of the invention. In this case, the sensor comprises in particular a so-called array of measuring electrodes for the locally resolved detection of measurement signals, whereby a measurement potential can be applied in particular alternately to a respective one of the measuring electrodes, e.g. by means of a switching device comprised by the sensor. In addition or alternatively, the active surface of the sensor may comprise, in addition to the at least one counter electrode, one or more further counter electrodes which, taken together, are referred to as a plurality of counter electrodes in the context of the invention. Either a shield potential or an excitation potential can be applied to a respective one of the counter electrodes using the switching device. In one of the above-described ways, the sensor can be set up by means of the measurement electronics to determine a threshold value, as well as a calibration value and a setting value, based on a plurality of detected first and second measurement signals, or to determine a plurality of threshold values based on the plurality of first and second detected measurement signals.

In addition, the invention proposes a measurement arrangement comprising a sensor, in particular a sensor as described above, wherein the sensor is in particular adapted to perform the method described above.

### BRIEF DESCRIPTION OF THE DRAWING

The invention is described in more detail below with reference to some preferred, but merely exemplary, embodiments with reference to the accompanying drawings. The drawings show:

FIG. 1: a schematic representation of the method according to one embodiment of the invention,

FIG. 2: a perspective view and a side view of a sensor according to the invention in accordance with a first embodiment of the invention, which is in particular set up to carry out the method according to the invention,

FIG. 3: a diagram of the time course of the method according to one embodiment of the invention,

FIG. 4: a perspective view and a side view of a sensor according to the invention in accordance with a second embodiment of the invention, which is in particular set up to carry out the method according to the invention,

FIG. 5: three side views of a sensor according to the invention in accordance with a third embodiment of the invention, which is in particular set up to carry out the method according to the invention,

FIG. 6: two side views of a sensor according to the invention in accordance with a fourth embodiment of the invention, which is in particular set up to carry out the method according to the invention,

FIG. 7: a side view of a sensor according to the invention in accordance with a fifth embodiment of the invention, which is in particular set up to carry out the method according to the invention,

FIG. 8: four side views of a sensor according to the invention in accordance with a sixth embodiment of the invention, which is in particular set up to carry out the method according to the invention,

FIG. 9: two side views of a sensor according to the invention in accordance with a seventh embodiment of the invention, which is in particular set up to carry out the method according to the invention, and

FIG. 10: four side views of a sensor according to the invention in accordance with an eighth embodiment of the invention, which is in particular set up to carry out the method according to the invention.

### DETAILED DESCRIPTION

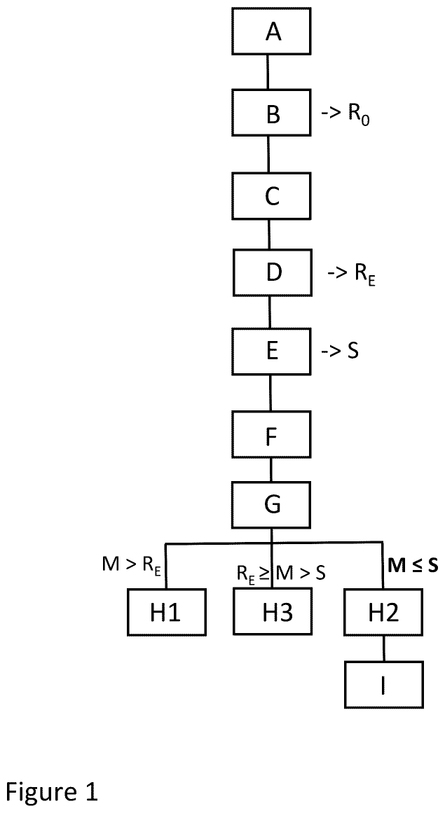

FIG. 1 shows a schematic representation of the method for detecting a measurement object in a measurement arrangement using a sensor according to one embodiment of the invention. The measurement object can in particular be a filling material, e.g. a liquid or a bulk material. In particular, the method can be a method for measuring a filling level in a vessel or for measuring a leakage from a vessel. In particular, the sensor is a proximity sensor for capacitively detecting measurement signals within a spatial measurement field of the sensor. The sensor used in the method has measurement electronics with an active surface, which comprises at least one measuring electrode and at least one counter electrode, and with an evaluation unit for evaluating a measurement signal detected by the at least one measuring electrode. The active surface of the sensor can therefore also comprise a plurality of measuring electrodes including the at least one measuring electrode, for example an array of measuring electrodes for locally resolved detection of corresponding measurement signals, and/or a plurality of counter electrodes including the at least one counter electrode. A measuring potential can be alternately applied to the respective measuring electrodes by means of a switching device of the sensor. An excitation potential or a shield potential can be applied to the respective counter electrodes using a switching device of the sensor. Depending on the number of measuring electrodes and counter electrodes, this results in a resulting number of measuring channels of the sensor and a corresponding number of recorded measuring signals or measured values.

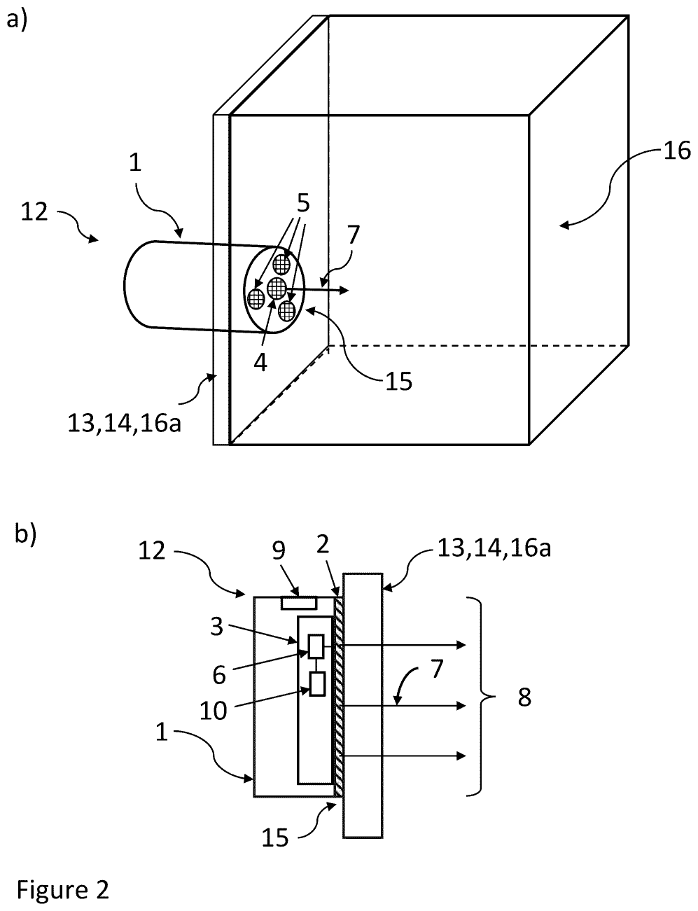

According to block A shown in FIG. 1, the method comprises the generation of a spatial measuring field by the sensor's measurement electronics. The measuring field extends essentially transversely to the active surface and starting from the active surface, as shown, for example, in FIG. 2, whereby the direction of action of the measuring field 8 is symbolized therein by an arrow marked with reference sign 7. According to block B of FIG. 1, a calibration value R₀ is determined by capacitively detecting and evaluating a first measurement signal or also several first measurement signals by means of the measurement electronics, namely before the sensor is attached to a surface of a measurement arrangement for measurement in a measurement position.

The determined calibration value R₀ is stored in the measurement electronics and corresponds to at least one measurement value of the sensor that has been determined as part of the capacitive detection of a number of first measurement signals in a state of the sensor in which the sensor is not in the measurement position but is exposed to an atmosphere that is also essentially present during the measurement process, as is usual in calibration measurements. In particular, this atmosphere is air, but in certain applications it can also be a vacuum, for example.

According to the block C sketched in FIG. 1, the sensor is attached to the surface of the measurement arrangement for measuring in the measuring position in which a component of the measurement arrangement is located within the measuring field of the sensor. The measurement position refers to the position intended for the sensor to take measurements, i.e. to capacitively detect measurement signals within its measurement field. For example, the sensor can be detachably attached to the surface using a holding device, which can also be designed as a component of the sensor. The measurement arrangement can, for example, comprise a vessel to whose surface the sensor is attached, whereby the surface can be, for example, a wall surface or a bottom surface of the vessel, in particular an outer wall surface or bottom surface, or even a bottom surface of a room.

After the sensor has been attached to the surface of the measurement arrangement and has assumed its measuring position or is in this position, a setting value R_{E} is determined according to block D of FIG. 1 when the sensor is in the measuring position and there is no measurement object within the measuring field by capacitively detecting and evaluating a second measurement signal by means of the measurement electronics and storing the determined setting value R_{E} in the measurement electronics, the setting value R_{E} being greater than the calibration value R₀. The setting value R_{E} thus corresponds to a reference value in relation to the measuring position of the sensor, whereby no measurement object is located within the measuring field of the sensor. The setting value R_{E} is greater than the calibration value R₀ due to an influencing variable caused by the component of the measurement arrangement located within the measuring field. This means that the component of the measurement arrangement is located within the measuring field due to the installation position of the sensor and causes a positive change in the measuring signals or the measured values of the sensor. The component of the measurement arrangement is in particular dielectric or conductive and can, for example, comprise the surface of the measurement arrangement to which the sensor is attached.

Based on the determined calibration value R₀ and the determined setting value R_{E}, a threshold value S is specified by the measurement electronics in block E of FIG. 1, which is defined by a value between the calibration value R₀ and the setting value R_{E}. This can be specified, for example, as a function of a difference between the setting value R_{E} and the calibration value R₀.

The parameters required for the evaluation of measurement signals, which include the calibration value R₀, the setting value R_{E} and the threshold value S, are now fixed. According to block F, a measurement process for detecting the measurement object within the measurement field is activated or started when the sensor is in the measurement position. Accordingly, according to block G of FIG. 1, a third measurement signal is capacitively detected and evaluated by the measurement electronics. In particular, this capacitive detection takes place at regular intervals or continuously. The electronic measuring system determines a measured value that corresponds to the evaluated detected third measurement signal and compares this measured value with the defined threshold value and, in particular, also with the setting value R_{E}. If, during the evaluation of the detected third measurement signal by the measurement electronics of the sensor, it is determined that this evaluated detected third measurement signal corresponds to a measured value M that is less than the specified threshold value S or equal to the specified threshold value S, which is symbolized by the calculation rule M≤S in FIG. 1, a warning signal is output in accordance with block H2 of FIG. 1, e.g. at the instigation of the measurement electronics. For example, the warning signal can be emitted by displaying the warning signal using a display device of the sensor, shown by block I in FIG. 1. Additionally or alternatively, the warning signal can be emitted by the sensor as an acoustic warning signal. In addition or alternatively, it may also be possible to output the warning signal via a separate sensor output, e.g. as an electronic signal. The warning signal indicates that the sensor is currently not or no longer in the measuring position or in its correct mounting position, but has moved away from it, e.g. has become detached. The warning signal is therefore evaluated as a current installation error or mounting error of the sensor and output accordingly.

If, however, during the evaluation of the detected third measurement signal by the measurement electronics of the sensor, it is determined that this evaluated detected third measurement signal corresponds to a measurement value M that is greater than the determined setting value R_{E}, which is symbolized by the calculation rule M>R_{E} in FIG. 1, a measurement object is detected and the detected third measurement signal is output, in particular in the form of a leakage measurement signal or a filling level measurement signal, e.g. by means of a sensor surrounded by the sensor. e.g. by means of a display device included in the sensor or as an electronic signal via a corresponding sensor output. If the measured value M corresponding to the evaluated detected third measurement signal is in a value range that is greater than the defined threshold value S and less than the determined setting value R_{E} or equal to the determined setting value R_{E}, this measurement result is interpreted by the measurement electronics as a missing presence of the measurement object within the measurement field and is also evaluated in such a way that there is currently no installation error or mounting error of the sensor. This is illustrated by the block H3 shown in FIG. 1. A warning signal is only issued in accordance with block H2 when the specified threshold value S is reached and/or undershot. The range of values between the setting value R_{E} and the threshold value S can therefore be regarded in particular as a tolerance range or fault tolerance range.

The respective capacitive detection of the first, the second and the third measurement signal can in particular comprise a capacitive detection of a respective plurality of first, second and third measurement signals, whereby this respective plurality is evaluated by the evaluation unit. In this case, the threshold value S can be specified based on the plurality of detected first and second measurement signals, e.g. by determining an averaged calibration value R₀ based on the plurality of detected first measurement signals and an averaged adjustment value R_{E} based on the plurality of detected second measurement signals, which are used to specify the threshold value. Alternatively, a plurality of threshold values Sᵢ can also be determined based on the plurality of detected first and second measurement signals, in particular in such a way that a respective threshold value Sᵢ is determined based on a respective detected first and second measurement signal of the plurality of detected first and second measurement signals.

This means that a respective threshold value can be defined for each measurement channel of the sensor. This can be particularly advantageous in the case of an active area of the sensor, which comprises an array of measuring electrodes, as it enables a locally resolved analysis of the measured values.

The respective plurality of first, second and third measurement signals described above can be recorded in particular by the active surface of the sensor having a plurality of measurement electrodes, whereby a measurement potential is applied to one of the plurality of measurement electrodes in each case by means of the measurement electronics, in particular alternately and by activating a switching device included in the sensor. This results in a plurality of measuring channels of the sensor, whereby a respective first, second and third measuring signal is recorded for each measuring electrode or measuring channel. Alternatively or additionally, the detection of the plurality of corresponding measurement signals can also be carried out by the active surface of the sensor having a plurality of counter electrodes and either a shield potential or an excitation potential being applied to each of the plurality of counter electrodes by means of the measurement electronics, e.g. by activating a switching device included in the sensor. Accordingly, an arrangement with n counter electrodes results in a total of 2ⁿ measuring channels or different measured values. The respective measured values of the individual measuring channels can be calculated mathematically with each other and used to determine one or more individual calibration values, one or more individual setting values R_{E} or R_{E,i} and thus to specify one or more threshold values.

The method illustrated in FIG. 1 is characterized in particular by the fact that a calibration value R₀ and additionally a setting value R_{E} are determined. This means that before the measurement process for detecting a measurement object takes place, two different reference values are first determined, of which a first reference value or the calibration value R₀ refers to a first state of the sensor in which the sensor is not in the measurement position, and a second reference value or the setting value R_{E} refers to a second state of the sensor in which the sensor is in the measurement position. The measuring position of the sensor corresponds to the position of the sensor that the sensor assumes after it has been properly attached to the surface of the measurement arrangement. Determining these two reference values, i.e. the calibration value R₀ and the setting value R_{E}, serves in particular to check or monitor during the measurement process for detecting the measurement object whether the sensor is still in its measurement position or whether the sensor has left its intended measurement position and consequently an mounting error or installation error is present.

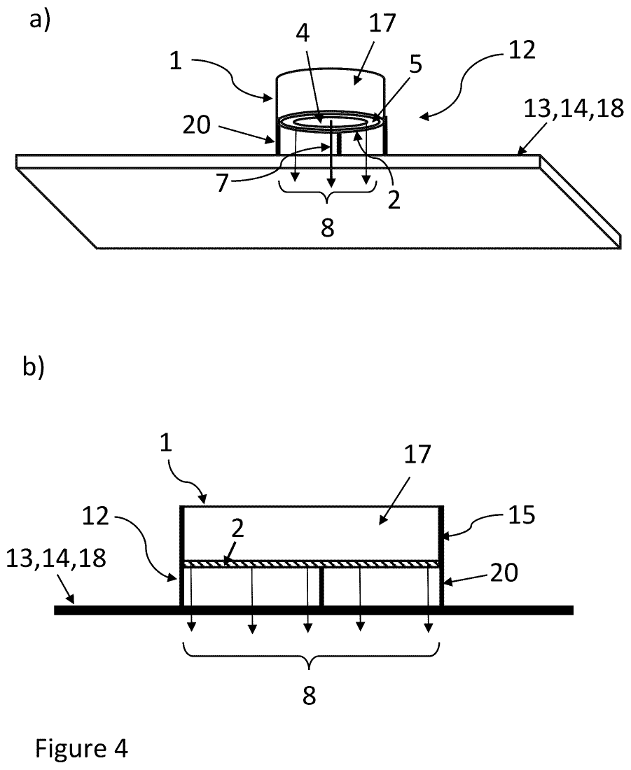

FIG. 2 shows a perspective view a) and a side view b) of a sensor 1 according to a first embodiment of the invention, which suitably carries out the method according to the invention in a measurement arrangement 12. The sensor according to FIG. 2 is exemplarily designed as a capacitive proximity sensor and is set up for detecting a measurement object in a measurement arrangement 12, namely for carrying out the method shown according to FIG. 1 and described above. In FIG. 2, the sensor is designed, for example, to capacitively detect a filling level within a vessel 16, whereby the measurement object to be detected corresponds to a filling material. As illustrated in FIG. 2b), the sensor 1 has measurement electronics 3 for generating a spatial measurement field 8 and for detecting a measurement object, in particular for capacitively detecting a filling material located in the vessel 16, within the measurement field 8. The electronic measuring system 3 comprises an active surface 2, which has at least one measuring electrode 4 and at least one counter electrode 5. In the embodiment example shown in FIG. 2, the active surface 2 as shown in the perspective view under a) has a measuring electrode 4 and a plurality of counter-electrodes 5, for example three counter-electrodes 5. The spatial measuring field 8 of the sensor 1 extends essentially transversely to the active surface 2 and starting from the active surface 2, which is illustrated by the arrow marked with reference sign 7 to indicate the direction of action of the measuring field in FIG. 2. In addition, the electronic measuring system 3 comprises an evaluation unit 6 for evaluating a measurement signal recorded by the at least one measuring electrode 4. The sensor 1 can be detachably attached to a surface 13 of the measurement arrangement 12, namely for measuring in a measuring position 15, in which a component 14 of the measurement arrangement 12 is located within the measuring field 8 of the sensor 1. The component 14 of the measurement arrangement 12 is in particular dielectric or conductive and can, for example, comprise the surface of the measurement arrangement to which the sensor is attached. In the embodiment example of FIG. 2, this component 14 corresponds to the surface 13 of the measurement arrangement 12 to which the sensor is to be attached in order to assume the measuring position 15. The component 14 of the measurement arrangement 12 does not necessarily have to comprise the surface 13 of the measurement arrangement 12, but can also be a component of the measurement arrangement other than the surface of the measurement arrangement, as shown, for example, in FIG. 4. According to FIG. 2, the measurement arrangement 12 comprises the vessel 16 and the sensor 1, which is attached to the surface 13 of the measurement arrangement 12 formed as the wall surface 16a of the vessel 16, with this wall 16a being dielectric in FIG. 2.

A calibration value can be stored or is already stored in the measurement electronics 3 of the sensor 1. In FIG. 2, the calibration value is already stored and is based on the respective first measurement signals that have been recorded by the measurement electrode 4 of the active surface 2 in a state of the sensor 1 that is not in the measurement position and evaluated by means of the evaluation electronics. According to FIG. 2, the calibration value is based, for example, on at least one of the first measurement signals recorded in each case, which result from the measurement channels depending on the circuit state of the respective counter electrodes 5 as an excitation electrode or as a shield electrode. As is usual in a calibration, the first measurement signals were recorded while the active surface 2 of the sensor 1 was exposed to an atmosphere or generally to an environment to which the sensor 1 will also be exposed during its measurement process for detecting a measurement object. In the embodiment example of FIG. 2, this atmosphere is ambient air, but in another embodiment it can also be a gas atmosphere or a vacuum. Furthermore, a setting value can be stored or is already stored in the measurement electronics 3 of the sensor 1. In FIG. 2, the setting value is already stored. The setting value is based on a number of respective second measurement signals, which result from the respective number of measurement channels depending on the circuit state of the respective counter electrodes 5 as excitation electrode or as shield electrode, whereby the second measurement signals are generated with the aid of the counter electrodes 5 of the active surface 2 in a state of the sensor 1 in the measurement position with no measurement object within the measurement field 8 and have been detected by means of the measurement electrode 4 and evaluated by means of the evaluation electronics. In the specific embodiment example of FIG. 2, the stored setting value is thus based on the second measurement signals respectively recorded by the measuring electrode 4, for example on an average value of the recorded second measurement signals. Due to an influencing variable caused by the component 14 of the measurement arrangement 12, which is located within the measuring field 8 of the sensor 1 when the sensor 1 is in the measuring position 15, the setting value is greater than the calibration value. The measurement electronics 3 of the sensor 1 is set up to specify a threshold value based on the calibration value and the setting value in such a way that this is defined by a value lying between the calibration value and the setting value, in particular as a function of a difference between the setting value and the calibration value.

According to FIG. 2, the sensor 1 is set up to start a measurement process for detecting a measurement object within the measurement field 8 when the sensor 1 is in the measurement position and to capacitively detect at least a third measurement signal, namely at least a number of third measurement signals corresponding to the number of counter-electrodes 5 surrounded by the active surface 2, by means of the measurement electronics 3 and to evaluate it by means of the evaluation electronics 6. A corresponding measurement process is shown in FIG. 2, although in FIG. 2 there is no measurement object within the measurement field 8 of sensor 1. Even if this is not evident from FIG. 2, the sensor is also set up to output a warning signal in the event that the third measurement signal detected and evaluated by the electronic measuring system 3 corresponds to a measured value that is less than or equal to the defined threshold value. As already mentioned, the exemplary sensor 1 shown in FIG. 2 detects at least one measurement signal due to its three counter-electrodes 5 surrounded by the active surface 2, namely in each case a third measurement signal of a respective measurement channel of a maximum of eight measurement channels resulting from the respective circuit state of the three counter-electrodes 5 as excitation electrode or as shield electrode by means of the measurement electrode 4, and evaluates the corresponding third measurement signals by means of the evaluation unit 6. The recorded third measurement signals can be compared individually with the previously determined threshold value and, in particular, also with the previously determined setting value. Alternatively, a number of the respective detected third measurement signals or a combination of detected third measurement signals, in which, for example, a number of the detected third measurement signals are calculated mathematically with each other, can be compared with a number of defined threshold values and, in particular, also with a number of previously determined setting values.

As already described with regard to the method shown in FIG. 1, the sensor 1 thus has a self-monitoring function integrated in the sensor 1 with regard to its installation position. The sensor 1 can check for itself whether its current position still corresponds to the predetermined measuring position. If this is not or no longer the case, i.e. if the sensor 1 is currently not or no longer in the intended measuring position during a measuring process, it emits a corresponding warning signal. This warning signal indicates a deviation of the sensor 1 from the intended measuring position 15, and thus a mounting error or installation error. The measuring process can then be aborted after the warning signal has been emitted in order to rectify the installation error.

In the normal case, i.e. when the sensor 1 is operating correctly, the sensor 1 detects a third measurement signal or also several third measurement signals, each of which corresponds to a measurement value that is greater than the specified threshold value. If a respective detected third measurement signal is also greater than the setting value, the sensor detects a measurement object, which corresponds to a filling material inside the vessel as shown in FIG. 2, and can calculate a filling level based on the number of detected third measurement signals. The detected third measurement signal or the number of detected third measurement signals can be output by the sensor 1 as shown in FIG. 2 in the form of a filling level measurement signal, e.g. using a display device 9 included in the sensor 1 or as an electronic signal via a sensor output. According to FIG. 2, there is no filling material in the vessel 16, and therefore no measurement object within the measuring field 8 of the sensor 1. This means that the third measurement signal detected in each case essentially corresponds to the setting value, i.e. taking into account error tolerances. As part of its self-monitoring function, the sensor therefore recognizes that it is in the intended measuring position and that there is no installation error or mounting error, and continues the measuring process.

The sensor 1 shown in FIGS. 4-9 essentially corresponds to the sensor illustrated in FIG. 2 in terms of its functional features and its mode of operating or functionality. The internal structure of the sensor 1 is therefore not shown in FIGS. 4-9, although the same reference symbols are used for the same features. The sensors 1 shown in FIGS. 2 and 4-9 differ essentially with regard to their application or area of use, and thus in their respective installation and the measuring positions they assume. Furthermore, the sensors may differ in particular in the number of measuring electrodes 4 and counter electrodes 5 covered by the active surface and in the presence of a switching device.

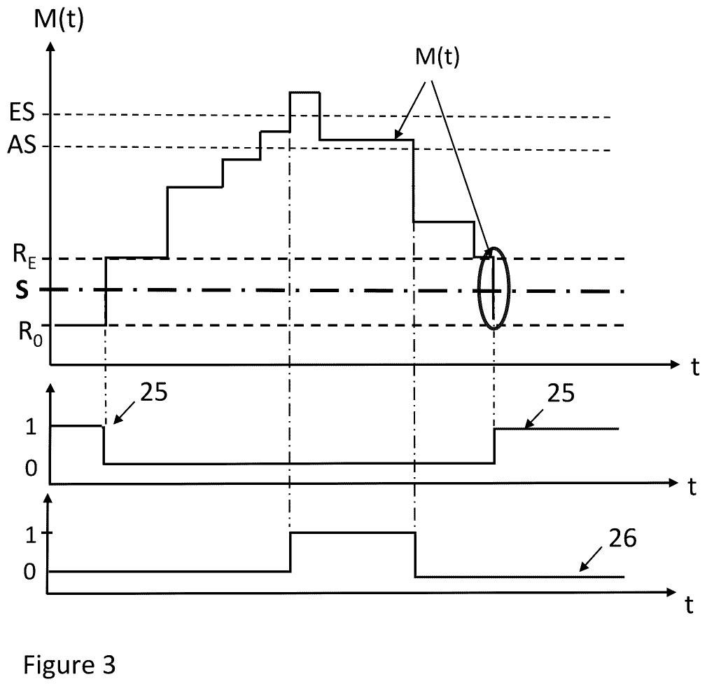

FIG. 3 shows a diagram of the progression over time of the method according to one embodiment of the invention. The diagram shows the progression of a measured value M(t) evaluated in the course of the capacitive detection of a third measurement signal over the time t. The diagram in FIG. 3 also shows the determined calibration value R₀, the determined setting value R_{E} and the threshold value S determined on the basis of the calibration value R₀ and the setting value R_{E} as corresponding straight lines. As soon as the sensor is in the intended measuring position, the measuring process can be activated or started. After a short switch-on time, during which the measured value M (t) is initially still below the threshold value S due to the switch-on process, a warning signal 25 is emitted. The measured value M(t) then initially rises to a value that corresponds to the setting value R_{E}. If a measurement object is located within the sensor's measurement field in the measurement position assumed by the sensor, the measured value M(t) rises to a value that is greater than the setting value R_{E.} If the measured value M(t) exceeds the switch-on threshold ES of the sensor, a switching signal 26 is output and the detected third measurement signals are evaluated in an application-specific manner as part of the measurement process for detecting the measurement object. If the measured value M(t) falls below the switch-off threshold AS of the sensor, a corresponding switching signal 26 is no longer output and the detected third measurement signals are no longer evaluated. The output of the switching signal 26 is therefore dependent on the switch-on threshold ES and the switch-off threshold AS of the measurement signal, whereby the switch-on threshold ES and the switch-off threshold AS must be defined in advance depending on the application. If the sensor is no longer in the intended measuring position, e.g. because it has become detached from the surface of the measurement arrangement, the proportion of the measurement object and the component of the measurement arrangement located within the measuring field of the sensor is reduced. As a result, the measured value M(t) determined by the sensor falls below the setting value R_{E} and ultimately also below the threshold value S. The measured value M(t) reaching and falling below the threshold value S is indicated by an oval marking in FIG. 3. If the sensor detects that the measured value M(t) has reached and fallen below the threshold value S, it emits a warning signal 25, as can be seen in the lower section of the diagram in FIG. 3.

FIG. 4 shows a perspective view a) and a side view b) of a further sensor 1 according to a second embodiment of the invention, which expediently carries out the method according to the invention in a measurement arrangement 12. The basic mode of operation of the sensor 1 shown in FIG. 4 and the method carried out by means of the sensor 1 correspond to the explanations in FIGS. 1 to 3. The sensor 1 shown in FIG. 4 differs essentially from the sensor shown in FIG. 2 in that its active surface 2 comprises exactly one measuring electrode 4 and exactly one counter electrode 5 and in that the sensor 1 has no switching device. This means that only one measurement channel is available for the capacitive detection of measurement signals. The calibration value, the setting value and also the measured value, which corresponds to the detected third measurement signal, can optionally be determined based on a plurality of first, second and third measurement signals detected, e.g. within a certain period of time, e.g. by determining an average value from the plurality of detected first, second and third measurement signals and using it to determine the calibration value, the setting value and/or the measured value.

The sensor 1 shown in FIG. 4 is used to detect a leakage. Generally speaking, material in the form of solids, liquids or gases can escape from a leakage. In the example shown in FIG. 4, the measurement object to be detected is a liquid escaping from a leakage point, which can reach the bottom of a room and accumulate on the bottom surface 18. To detect this, the sensor 1 is detachably attached to a surface 13 of the measurement arrangement 12, which in FIG. 4 is designed as a bottom surface 18, by means of a separate holding device 20, which is therefore not designed as a component of the sensor 1, so that the end face of the sensor 1, which comprises the active surface 2, is arranged opposite the bottom surface 18 in the measuring position 15 and at a defined distance from the bottom surface 18. For example, the holding device 20 can be placed on the bottom of the room and the sensor 1 can, for example, be attached to the holding device 20 while sitting on it. It goes without saying that the measuring field 8 of the sensor 1 is generated by the measurement electronics in such a way that the measuring field 8 extends from the active surface 2 to the bottom surface 18 and slightly beyond it, so that the bottom surface 18 and a measurement object possibly located on the bottom surface 18 are located within the measuring field 8 and can be metrologically detected by the sensor 1. According to FIG. 4, however, there is still no measurement object or liquid within the measurement field 8 of the sensor 1. In contrast to FIG. 2, the component 14 of the measurement arrangement 12 located within the measurement field 8 thus represents the bottom surface 18 of a room as an example and, in contrast to FIG. 2, does not include the surface 13 of the measurement arrangement 12 to which the sensor 1 is attached for measurement in the measurement position 15.

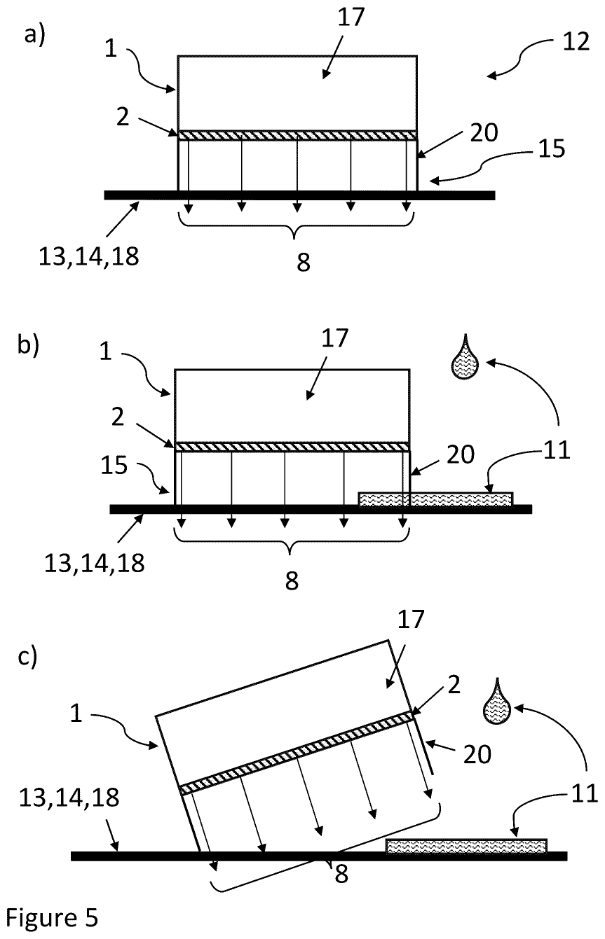

FIG. 5 shows three side views a), b) and c) of a further sensor 1 according to a third embodiment of the invention, which expediently carries out the method according to the invention in a measurement arrangement 12. The sensor 1 shown in FIG. 5 corresponds to the sensor shown in FIG. 4 in terms of its mode of operating and functionality. Accordingly, the sensor 1 according to FIG. 5 also serves to detect a leakage or to detect a measurement object 11, which is a liquid escaping from a leakage point and which can reach the bottom of the room from the leakage point and accumulate on the bottom surface 18. In FIG. 5, the sensor 1 is also attached to a surface 13 of a measurement arrangement 12 using a holding device 20 and is located in the measuring position 15 in FIG. 5a) and b). The measurement arrangement 12 shown in FIG. 5 differs from FIG. 4 in that the sensor 1 is attached or mounted to a surface 13 of the measurement arrangement 12, which is designed as a bottom surface 18 of the room, by means of a holding device 20, which is designed as a component of the sensor housing 17, in particular a suitably designed holding device 20, in order to assume the measuring position 15. In FIG. 5, the bottom surface 18 corresponds to the component 13 of the measurement arrangement 12 and is located within the measuring field 8 of the sensor 1 when the sensor 1 is in the measuring position 15 (see FIG. 5b)). The bottom surface 18 is in particular dielectric and, due to its presence within the measuring field 8 of the sensor 1, causes the setting value to be greater than the calibration value of the sensor, as already described. The measuring field 8 is of course generated by the measurement electronics of the sensor 1 in such a way that the measuring field 8 extends from the active surface 2 at least up to and including the bottom surface 18 and in particular slightly beyond it, as can be seen in FIG. 5.

According to FIG. 5a), the sensor is in the measuring position 15 and there is no measurement object within the measuring field of the sensor 1. The third measuring signal detected by the sensor 1 therefore corresponds to a measured value that essentially corresponds to the setting value. According to FIG. 5b), the sensor 1 is also in the measuring position 15 and a liquid has accumulated on the bottom surface 18 due to a leakage from a vessel located above the sensor (not shown in FIG. 5 for the sake of clarity). Since the liquid corresponding to the measurement object 11 to be detected is located within the measurement field 8 of the sensor 1, it is determined during the capacitive detection of a third measurement signal that the measurement value resulting from the detected third measurement signal is greater than the setting value. Accordingly, the detected third measurement signal is output as a leakage measurement signal. FIG. 5c) shows that, in contrast to FIG. 5a) and 5b), the sensor 1 is no longer in the measuring position and therefore no longer in the intended installation position. The measurement object 11 or the leakage liquid to be detected is no longer within the measurement field 8 of the sensor 1 due to the changed position of the sensor 1. Accordingly, the sensor 1 detects a third measurement signal that corresponds to a measurement value that undergoes a negative measurement value change compared to the measurement value evaluated in the state of the sensor 1 according to FIG. 5b), reaches the threshold value and falls below it. The sensor 1 recognizes this by means of its evaluation unit and emits a warning signal, as already described, to indicate that there is an installation error in the sensor 1.

For example, according to the embodiment examples shown in FIGS. 4 and 5, the sensor can also be mounted above or in front of a bottom surface, in particular by means of a holding device, whereby the bottom surface is a metallic bottom surface, which can also be earthed in an electrically conductive manner.

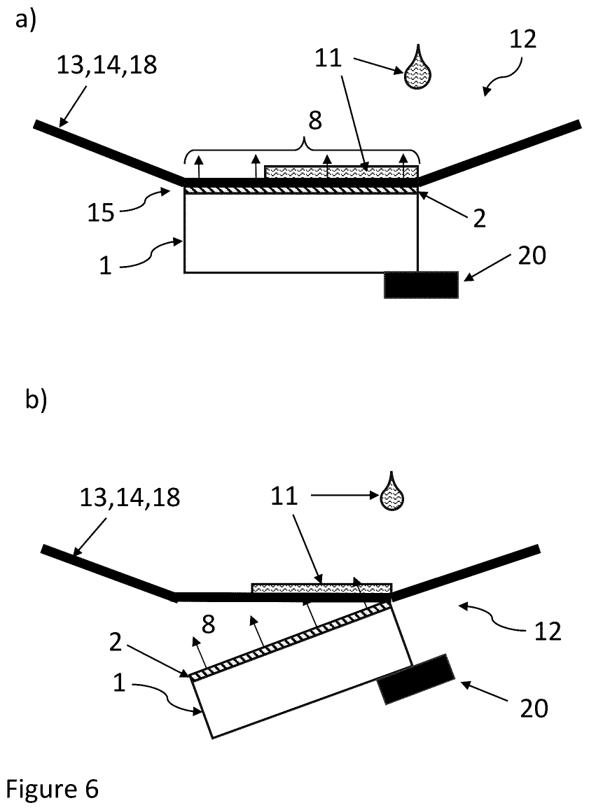

FIG. 6 shows two side views a) and b) of a further sensor 1, which expediently carries out the method according to the invention in a measurement arrangement 12 according to a fourth embodiment of the invention. In FIG. 6a), the sensor 1 is attached directly, i.e. with one surface of the sensor 1 directly to a surface 13 of a measurement arrangement 12, in particular using an optional separate holding device 20, and is located in the measuring position 15 for detecting a measurement object 11. The holding device 20 can be designed in various ways and need only be suitable for attaching the sensor 1 to the surface 13 of the measurement arrangement 12, in particular detachably, and for holding it in the measuring position. For example, the holding device 20 can be part of a wall or a bottom or, instead of a mechanical holding device, can also be designed, for example, in the form of an adhesive or adhesive pad for attaching the sensor 1 to the surface 13 of the measurement arrangement 12. In a further embodiment, the holding device can, for example, be designed as a component of the sensor 1, e.g. in the form of suction cups or the like. The surface 13 of the measurement arrangement 12 is designed as a bottom surface 18, in particular as an outer bottom surface, of a vessel 16 designed as a tub. The tub can, for example, be designed as a collecting tub for collecting the measurement object 11 to be detected, which in FIG. 6 corresponds to a filling material escaping from a leakage. As can be seen in FIG. 6b), the sensor 1 has detached itself from the surface 13 of the measurement arrangement 12 or the outer bottom surface 18 of the tub and is no longer in the measuring position 15 as shown in FIG. 6a). Both the component 14 of the measurement arrangement 12, which corresponds to the bottom surface 18 of the tub in FIG. 6, and the measurement object 11, in the form of the filling material on the tub bottom, are now only partially within the measuring field 8 of the sensor 1. During the measuring process for detecting the measurement object 11, the sensor thus determines that the detected third measuring signal corresponds to a measured value which, compared to the measured value evaluated according to FIG. 6a), has undergone a negative change in the measured value. As soon as the detected third measurement signal corresponds to a measured value that is equal to or falls below the threshold value, the sensor 1 consequently emits a warning signal.

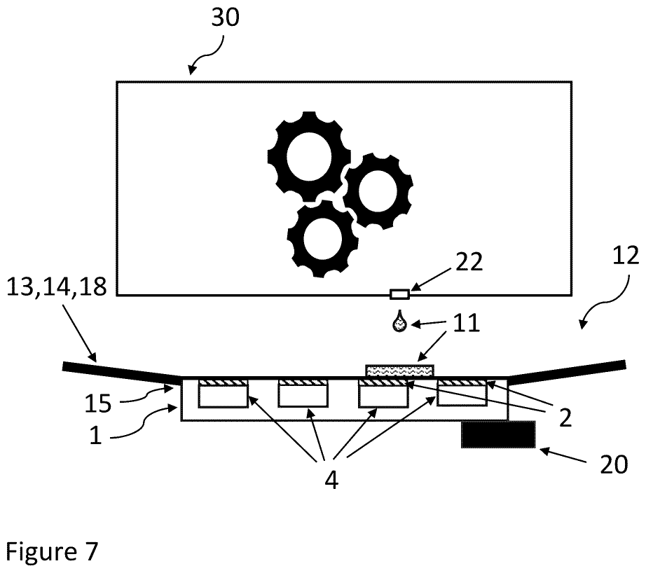

FIG. 7 shows a side view of a further sensor 1 according to a fifth embodiment of the invention, which expediently carries out the method according to the invention in a measurement arrangement 12, and describes a further possible application of the method and the sensor according to the invention. A machine 30 is shown which has a leakage point 22 from which a liquid, e.g. oil, is leaking undesirably. In the embodiment example of FIG. 7, the escaping liquid is the measurement object 11 to be detected by the sensor as part of the method. A vessel, e.g. a tub, is located below the machine 30 to collect the liquid. As an alternative to the embodiment shown in FIG. 6, in which the sensor is attached directly to the outer bottom surface of the tub for measuring the measurement object 11 in the measuring position, the sensor 1 according to FIG. 7 is inserted in a recess or cut-out in the bottom of the tub and is held in this position by means of a separate holding device 20, shown as an example in FIG. 7, which is not part of the sensor 1. The sensor 1 is installed in the recess in the bottom of the tub in such a way that the active surface 2 is directed towards the inner bottom surface of the tub in order to detect a liquid located on it as a measurement object 11. Consequently, the measuring field of the sensor 1 extends from the active surface 2 into the interior of the tub. A partial area of the bottom of the tub is located within the measuring field of the sensor 1 when it is installed in the recess and is in the measuring position.

According to FIG. 7, the sensor 1 has an active surface 2 which comprises a plurality of measuring electrodes 4, whereby four measuring electrodes 4 are shown in FIG. 7 for the sake of clarity, but in particular more measuring electrodes may also be present. The plurality of measuring electrodes 4 are arranged next to each other in the form of an electrode array, for example. The sensor also comprises a switching device, not shown in FIG. 7, by means of which a measuring potential can be applied to one of the plurality of measuring electrodes by means of the measurement electronics by activating the switching device, in particular alternately to each of the measuring electrodes, e.g. at predetermined time intervals. The evaluation unit of the sensor 1 is set up to evaluate a respective first, second and third measurement signal detected by each of the plurality of measuring electrodes. This configuration of the active surface 2 enables the measurement object 11 to be detected with an improved local resolution using the third measurement signals recorded by the plurality of measurement electrodes 4 and also enables the calibration value and the setting value to be determined more accurately based on the plurality of first and second measurement signals recorded. The active surface 2 of the sensor 1 also comprises at least one counter electrode, specifically one counter electrode in FIG. 7, which is not shown for the sake of clarity. In a further embodiment, the active surface of the sensor can optionally also have a plurality of counter-electrodes, whereby either a shield potential or an excitation potential can be applied to each of the plurality of counter-electrodes by means of the switching device.

Accordingly, the sensor 1 shown in FIG. 7 is set up by means of its measurement electronics to determine several threshold values based on the plurality of detected first and second measurement signals. This can be done, for example, in such a way that a respective threshold value is determined based on a respective detected first and second measurement signal of the respective plurality, and consequently based on a respective calibration value and a respective setting value of a plurality of determined calibration values and determined setting values. As an alternative to determining several threshold values, it is also possible to determine only a single threshold value based on the plurality of detected first and second measurement signals. This can be done in various ways, e.g. by determining a single calibration value and a single setting value, both of which are used to determine the threshold value, based on the plurality of detected first and second measurement signals, in particular by averaging a calibration value and a setting value. If the sensor 1 unintentionally leaves its installation position shown in FIG. 7, and thus the measurement position, this can be determined using the multiple threshold values and the multiple capacitively recorded third measurement signals with a spatial resolution based on the geometry of the measuring electrode array.

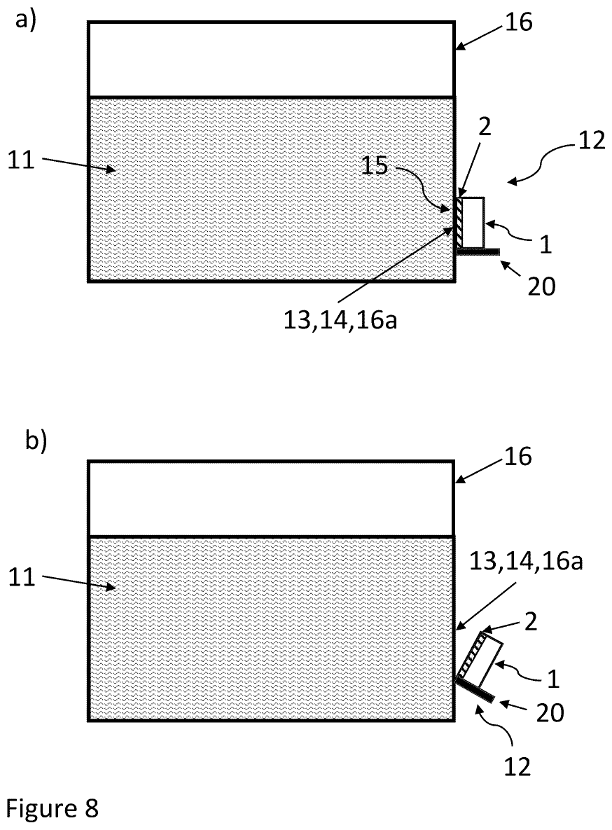

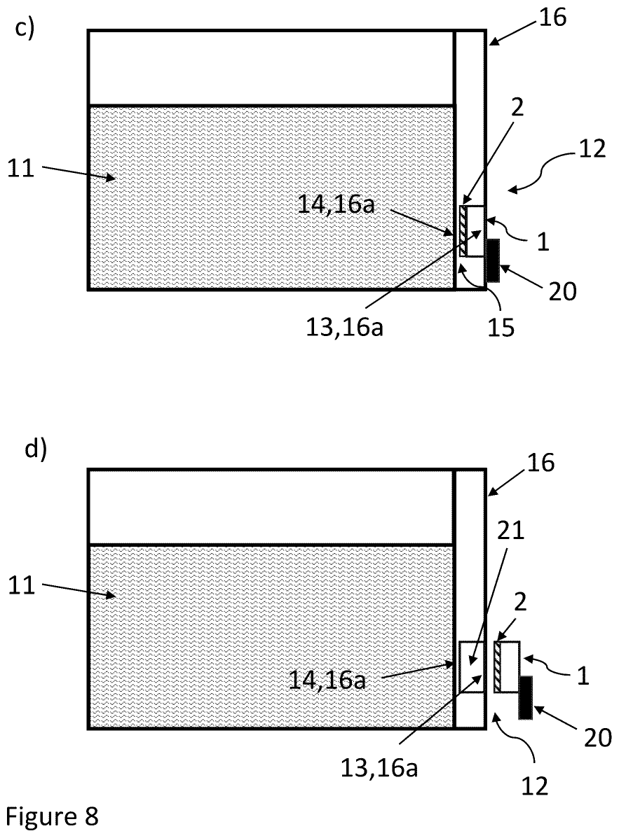

FIG. 8 shows four side views a), b), c) and d) of a further sensor 1 according to a sixth embodiment of the invention, which expediently carries out the method according to the invention in a measurement arrangement 12. The sensor 1 comprises an active surface 2 with at least one measuring electrode and at least one counter electrode and corresponds to the sensor described in FIG. 2 in terms of its internal structure and mode of functionality. According to FIG. 8a), the sensor 1 is detachably attached with its end face, which comprises the active face 2, to a surface 13 of a measurement arrangement 12, which is designed as the wall surface 16a of a vessel 16, in particular as the outer wall surface of a vessel 16, by means of a holding device 20 and is located in the measuring position 15. In FIG. 8a) and b), the holding device 20 is exemplarily designed as a holding element to be attached to the wall surface 16a of the vessel 16 and is also exemplarily a component of the sensor 1, although in a further embodiment the holding element can also be designed as a separate holding device or as a component of the vessel 16, e.g. in the form of a projection. As can be seen in FIG. 8a), the sensor 1 is used to capacitively detect a filling level within the vessel 16 or the container. The measurement object 11 to be detected by the sensor 1 during the measuring process is a filling material in the vessel 16. FIG. 8a) shows proper operation of the sensor 1, in whose measuring field the measurement object 11 is located in addition to the component 14 of the measurement arrangement 12, i.e. the wall of the vessel 16, in particular the dielectric or conductive wall. Accordingly, during the capacitive detection and evaluation of a respective third measurement signal, it is determined that the respective resulting measurement value is greater than the stored setting value. The respective third measurement signal is then output in the form of a filling level measurement signal, e.g. using a display device 9 shown in FIG. 2 or as an electronic signal via a sensor output provided for this purpose.

According to FIG. 8c), the sensor 1 is detachably attached with its end face, which comprises the active face 2, to a surface 13 of a measurement arrangement 12, which is designed as a wall surface 16a of a vessel 16, in particular as an outer wall surface, in a recess 21 of a side wall of the vessel 16 and is located in the measuring position 15. In FIG. 8c) and d), the side wall of the vessel 16 has, by way of example, a corresponding recess 21 for the sensor 1 and the sensor 1 is held in this recess 21 by a holding device 20, for example in the form of a clamping device. As can be seen in FIG. 8c), the sensor 1 is used to capacitively detect a filling level within the vessel 16 or the container. The measurement object 11 to be detected by the sensor 1 during the measuring process is a filling material located in the vessel 16. FIG. 8c) shows proper operation of the sensor 1, in whose measuring field the measurement object 11 is located in addition to the component 14 of the measurement arrangement 12, i.e. the inner wall surface 16a of the vessel 16, which is dielectric or conductive in particular.

Accordingly, during the capacitive detection and evaluation of a respective third measurement signal, it is determined that the respective resulting measurement value is greater than the stored setting value. The respective third measurement signal is then output in the form of a filling level measurement signal, e.g. by means of a display device 9 shown in FIG. 2 or as an electronic signal via a sensor output provided for this purpose.

According to FIG. 8b) and 8d), the sensor 1 is not or no longer in the measuring position, but rather has detached itself from the surface 13 of the measurement arrangement 12 or the wall surface 16a of the vessel 16. This may have been caused, for example, by a defect in the holding device 20, so that it can no longer hold the sensor 1 in the measuring position. The measurement object 11 and the component 14 of the measurement arrangement 12, which in FIG. 8b) is the wall of the vessel 16 and in FIG. 8d) is the inner wall surface 16a, are therefore only partially (see FIG. 8b)) or no longer at all (see FIG. 8d)) within the measurement field of the sensor 1.

Accordingly, during the capacitive detection and evaluation of the respective third measurement signal, the sensor 1 recognizes that the corresponding measured value has undergone a negative change in measured value compared to the measured value obtained according to FIG. 8a) or 8c). As soon as the sensor 1 detects that the measured value reaches the threshold value and in particular falls below it, it emits a warning signal. In particular, the sensor 1 indicates an installation error visually by means of its display device, e.g. on a screen, and/or it emits the warning signal via a separate output of the sensor, e.g. in the form of an electrical signal, and/or it emits the warning signal as an acoustic warning signal by means of a device included in the sensor.

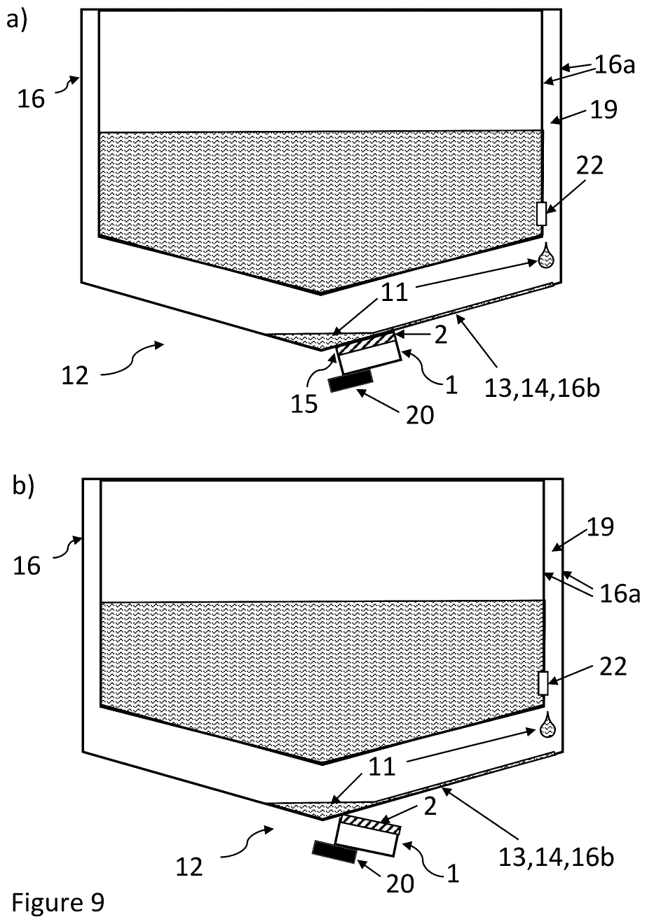

FIG. 9 shows two side views a) and b) of a further sensor 1 according to a seventh embodiment of the invention, which expediently carries out the method according to the invention in a measurement arrangement 12. The sensor 1 comprises an active surface 2 with at least one measuring electrode and at least one counter electrode and corresponds to the sensor described in FIG. 2 in terms of its internal structure and mode of functionality. The sensor shown in FIG. 9 is exemplarily designed as a leakage sensor or LEAK sensor and is set up to detect a measurement object 11 which corresponds to a filling material escaping from a leakage point 22 of a vessel 16, and is thus used to detect a leakage. According to FIG. 9a), the sensor 1 is located in the predetermined measuring position 15, in which it is attached with its end face, which comprises the active face 2, to the surface 13 of the measurement arrangement 12 by means of a holding device 20, whereby the holding device 20 must be suitable for attaching the sensor 1 to the surface 13 of the measurement arrangement 12 accordingly and holding it in the measuring position, as already described above, and is not a component of the sensor 1 in FIG. 9. In FIG. 9, the surface of the measurement arrangement 12 represents the bottom surface 16b of the vessel 16. In FIG. 9, the vessel 16 is designed with an inner wall and an outer wall as well as an inner bottom and an outer bottom, wherein a cavity 19 is located between the wall surface 16a of the inner wall and the wall surface 16a of the outer wall as well as between the bottom surface of the inner bottom and the bottom surface 16b of the outer bottom. In FIG. 9, the vessel 16 has an undesired leakage point 22, from which the filling material escapes from the interior of the vessel 16 into the cavity 19. The filling material or measurement object 11 that has entered the cavity 19 collects in the lower area of the cavity 19 between the outer and inner bottom surface 16b and can be detected by the sensor 1 as part of the capacitive detection of a third measurement signal, because both the outer bottom of the vessel, which corresponds to the component 14 of the measurement arrangement 12 according to FIG. 9, and the filling material corresponding to the measurement object 11 are located within the measurement field of the sensor 1.

In FIG. 9b), the sensor 1 is not or no longer in the measuring position 15, but has detached itself from the bottom surface 16b of the vessel 16, which can occur in particular due to a defect in the holding device 20. The measurement object 11 and the component 14 of the measurement arrangement 12, which is designed as the outer bottom of the vessel 16, are only partially within the measuring field. As soon as the sensor 1 detects during the capacitive detection and evaluation of a third measurement signal that the corresponding measured value reaches or falls below the threshold value, it emits a warning signal, as described above.

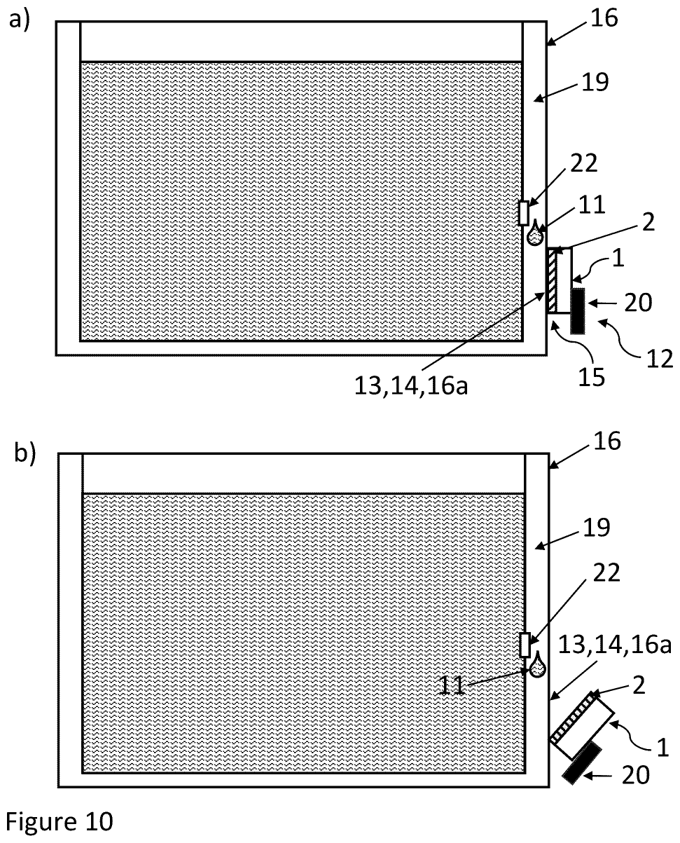

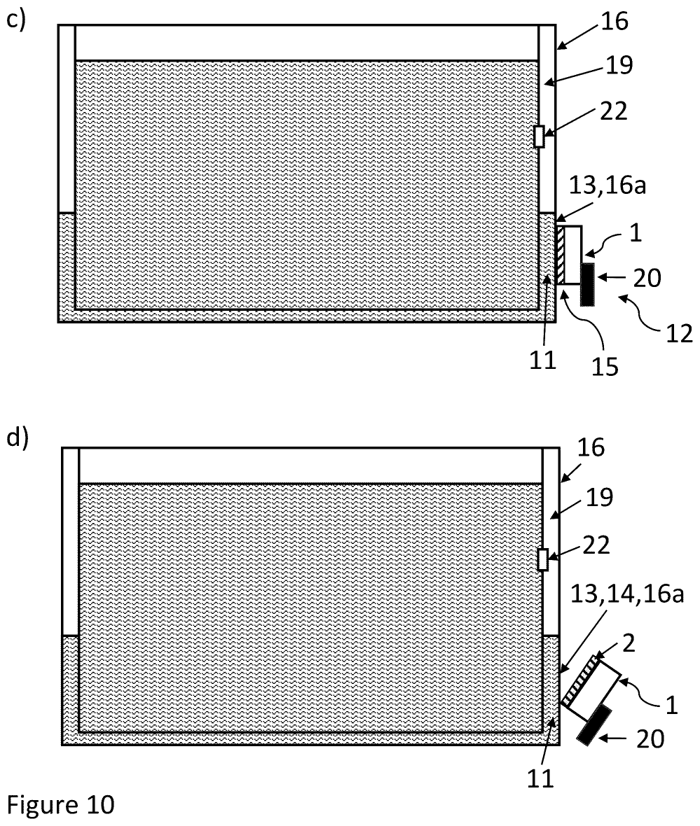

FIG. 10 shows four side views a), b), c) and d) of a further sensor 1 according to an eighth embodiment of the invention, which expediently carries out the method according to the invention in a measurement arrangement 12. The measurement arrangement 12 shown in FIG. 10 differs from FIG. 9 essentially only in the geometric shape of the vessel 16 and in the mounting of the sensor 1 on a different surface 13 of the measurement arrangement 12, namely on a wall surface 16a of the vessel 16, and thus in the measuring position 15 of the sensor 1. As in FIG. 9, the sensor 1 is also attached to the surface 13 in FIG. 10 with the aid of a, in particular separate, holding device 20. While FIG. 10 a) and 10 b) each show the sensor 1 in the state in which it is in the measuring position 15, FIG. 10c) and 10d) each show the sensor 1 in a state in which it is not or no longer in the measuring position. Accordingly, in FIG. 10c) and 10d), a warning signal is emitted when the sensor 1 detects a measured value resulting from the detected third measurement signal that is equal to or falls below the threshold value.

According to FIG. 10a)-d), the vessel 16 has a leakage point 22 from which filling material can enter from the interior of the vessel into a cavity 19 of a double wall, as already described for FIG. 9. In FIG. 10a) and 10b), no filling material, which corresponds to the measurement object 11 to be detected, has yet accumulated inside the cavity 19, so that the sensor 1 cannot detect any measurement object 11 as shown in FIG. 10a). It should be noted that the measuring field of the sensor 1 is always generated by the measurement electronics in such a way that the function of the sensor 1 is fulfilled in the best possible way. With reference to FIG. 10, this means that the measuring field extends from the active surface 2 essentially only up to and including the inner wall surface of the vessel 16, so that a filling material inside the vessel 16 is not incorrectly interpreted by the sensor 1 as a leakage or as a filling material escaping from the leakage point 22. In FIG. 10b) and 10d), on the other hand, a larger amount of filling material has already accumulated inside the cavity 19, so that the sensor 1 in FIG. 10c) detects this filling material as a measurement object 11 and can output a leakage measurement signal as a third measurement signal.

The present invention thus relates in summary to a method, a sensor 1 and a measurement arrangement 12 for detecting a measurement object 11 with a self-monitoring function of the sensor with regard to its position. In order to enable the self-monitoring function of the sensor, it is necessary for the sensor to be calibrated before it is mounted, i.e. the active surface 2 of the sensor must be exposed to an atmosphere, e.g. air or vacuum, during a calibration measurement, which is also present during the measurement process, among other things in order to suppress so-called pre-attenuation and installation tolerances due to potting compound, housing parts, circuit components, etc. During calibration, the positive measured value changes caused by the pre-attenuation are stored. Furthermore, a so-called empty adjustment is carried out as part of the so-called empty setting of the sensor, which takes place in the measuring position or in the final or intended mounting position of the sensor without the presence of the measurement object, in particular a filling material. Due to the installation position of the sensor, a wall or a bottom of the measurement arrangement, for example, comes in front of the active surface of the sensor and thus in its measuring field 8, which causes a further positive change in the sensor signals and thus a positive change in the measured value. The positive change in the measured value is determined and stored as a setting value, which is therefore greater than the calibration value resulting from the calibration measurement. After the empty setting, a threshold value is defined between the setting value and the calibration value by means of the measurement electronics, e.g. by means of device software included in this, which is dependent in particular on the signal change between the calibration value and the setting value. A threshold value can be defined, for example, on the basis of a combination of measured values or their relationship to each other or on the basis of normalized differences of measured values, whereby the measured values can be logically linked to each other in different functional relationships. Several threshold values can also be defined, for example in the case of an active surface comprising a plurality of measuring electrodes. Based on the setting value, negative measured value changes occurring as part of the capacitive detection of measurement signals mean that an incorrect mounting of the sensor is given, whereby the sensor has become detached or moved away from the measurement position or correct mounting position. It goes without saying that a holding device that can be used to attach the sensor in the intended mounting position or in the measuring position, as well as the respective mounting type of the sensor, must be designed in such a way that it is ensured that the sensor experiences a negative change in the measured value when it is loosened and removed from the correct mounting position. The sensor according to the invention is thus capable of independently detecting a change in the installation position only by evaluating its own sensor signals, i.e. without using additional auxiliary signals such as position sensors integrated in the sensor, integrated circuits or another auxiliary measurement. The method according to the invention using such a sensor therefore offers the possibility of detecting a faulty, undesired installation position of the sensor or a position of the sensor that deviates from the measured position in a quick, simple and efficient manner.

### LIST OF REFERENCE SYMBOLS

1 sensor
2 active surface
3 measurement electronics
4 measuring electrode
5 counter electrode
6 evaluation unit
7 direction of action measuring field
8 measuring field
9 display device
10 switching device
11 measurement object
12 measurement arrangement
13 surface of the measurement arrangement
14 component of the measurement arrangement
15 measuring position
16 vessel
16a wall surface of the vessel
16b bottom surface of the vessel
17 sensor housing
18 bottom surface of a room
19 cavity
20 holding device
21 recess
22 leakage point
25 warning signal
26 switching signal
30 machine
R₀, R_{0,i} calibration value
R_{E}, R_{E,i} setting value
S, Sᵢ threshold value
t threshold time
A(t) amplitude of the measurement signal
M measured value
ES switch-on threshold
AS switch-off threshold
A creation of a measuring field
B determine a calibration value
C attaching the sensor
D determining a setting value
E specifying a threshold value
F activating a measurement process
G capacitive detection and evaluation of a third measurement signal
H1 output of the third measurement signal
H2 output of a warning signal
H3 output of the third measurement signal
I display of a warning signal

1. A measuring method for detecting a measurement object in a measurement arrangement by a sensor, the sensor having measurement electronics with an active surface, which has at least one measuring electrode and at least one counter electrode, and with an evaluation unit for evaluating a measuring signal detected by the at least one measuring electrode, comprising the steps:
generating a spatial measurement field by the measurement electronics of the sensor, the measurement field extending essentially transversely to the active surface and starting from the active surface,
determining a calibration value by capacitively detecting and evaluating a first measurement signal by the measurement electronics of the sensor, namely before the sensor is attached to a surface of a measurement arrangement for measurement in a measurement position, and storing the calibration value in the measurement electronics of the sensor,
attaching the sensor to the surface of the measurement arrangement for measuring in the measuring position in which a component of the measurement arrangement is located within the measuring field of the sensor,
determining a setting value by capacitively detecting and evaluating a second measurement signal by the measurement electronics of the sensor when the sensor is located in the measurement position and when the measurement object is missing within the measurement field of the sensor, and storing the setting value in the measurement electronics of the sensor, the setting value being greater than the calibration value,
specifying a threshold value by the measurement electronics in such a way that this is defined by a value lying between the calibration value and the setting value,
activating a measurement process for detecting the measurement object within the measurement field when the sensor is in the measurement position,
capacitively detecting and evaluating of a third measurement signal by the measurement electronics of the sensor, and
in the event that the detected third measurement signal evaluated by the measurement electronics corresponds to a measurement value which is less than the specified threshold value or equal to the specified threshold value, outputting a warning signal.

2. The measuring method according to claim 1, wherein the threshold value is specified by the measurement electronics as a function of a difference between the setting value and the calibration value.

3. The measuring method according to claim 1, further comprising at least one of the steps:
displaying the warning signal by a display device of the sensor,
outputting the warning signal as an acoustic warning signal by the sensor, and
outputting the warning signal via a separate sensor output, as a digital signal.

4. The measuring method according to claim 1, wherein the capacitive detection of the first, the second and the third measurement signal comprises a capacitive detection of a respective plurality of first, second and third measurement signals, each of which is evaluated by the evaluation unit,
wherein the threshold value is specified based on the plurality of detected first and second measurement signals, or
wherein a plurality of threshold values are specified based on the plurality of detected first and second measurement signals, in such a way that a respective threshold value is determined based on a respective detected first and second measurement signal of the plurality of detected first and second measurement signals.

5. The measuring method according to claim 4, wherein the respective plurality of first, second and third measurement signals is detected and wherein:
the active surface of the sensor has a plurality of counter electrodes and either a shield potential or an excitation potential is applied to each of the plurality of counter electrodes by the measurement electronics, in particular alternately by activating a switching device comprised by the sensor, the respective plurality of first, second and third measurement signals being detected by the at least one measuring electrode, and/or
the active surface of the sensor has a plurality of measuring electrodes and a measuring potential is applied to one of the plurality of measuring electrodes in each case by the measurement electronics, in particular alternately by activating a switching device surrounded by the sensor, and a respective first, second and third measuring signal of the plurality of first, second and third measuring signals is detected by each of the plurality of measuring electrodes.

6. The measuring method according to claim 1, wherein the sensor is attached to the surface of the measurement arrangement by detachable attachment by a holding device, wherein the surface of the measurement arrangement is a wall surface or a bottom surface of a vessel or a bottom surface of a room.

7. The measuring method according to claim 1, wherein the component of the measurement arrangement is dielectric or conductive and comprises the surface of the measurement arrangement to which the sensor is attached in the measuring position.

8. The measuring method according to claim 1, wherein, in the case of an evaluated detected third measurement signal which is greater than the determined setting value, the measurement object is detected and the third measurement signal is output in the form of a leakage measurement signal or a filling level measurement signal, by a display device comprised by the sensor.

9. A proximity sensor for detecting a measurement object in a measurement arrangement, the sensor comprising:
measurement electronics for generating a spatial measurement field and for detecting a measurement object within the measurement field with
an active surface, which has at least one measuring electrode and at least one counter electrode, the measuring field extending essentially transversely to the active surface and starting from the active surface, and
an evaluation unit for evaluating a measurement signal detected by the at least one measuring electrode,
wherein the sensor can be attached to a surface of a measurement arrangement, namely for measuring in a measuring position in which a component of the measurement arrangement is located within the measuring field of the sensor,
wherein a calibration value can be stored or is stored in the measurement electronics, which calibration value is based on a first measurement signal which has been detected in a state of the sensor which is not in the measurement position, and a setting value can also be stored or is stored in the measurement electronics, which setting value is based on a second measurement signal which has been detected in a state of the sensor which is in the measurement position when the measurement object is missing within the measurement field,
wherein the adjustment value (R_{E}) is greater than the calibration value,
the measurement electronics being set up to specify a threshold value (S) in such a way that this is defined by a value lying between the calibration value and the setting value, and
the sensor is set up to start a measurement process for detecting the measurement object within the measurement field when the sensor is in the measurement position and to capacitively detect and evaluate a third measurement signal by the measurement electronics, and furthermore, in the event that the detected third measurement signal evaluated by the measurement electronics corresponds to a measurement value which is less than the defined threshold value or equal to the defined threshold value, to output a warning signal.

10. The sensor according to claim 9, wherein the measurement electronics are set up to specify the threshold value as a function of a difference between the setting value and the calibration value.

11. The sensor according to claim 9, further comprising a separate sensor output for outputting the warning signal, and/or
a display device which is set up to visually display the warning signal, and/or
a device which is designed to emit an acoustic warning signal.

12. The sensor according to claim 9, wherein the measurement electronics is set up to specify the threshold value based on a plurality of detected first and second measurement signals or to determine a plurality of threshold values based on a plurality of detected first and second measurement signals, and to determine a respective threshold value based in each case on a detected first and second measurement signal of the plurality of detected first and second measurement signals.

13. The sensor according to claim 9, wherein the sensor comprises a switching device (10) provided by the measurement electronics, and
the active surface of the sensor has a plurality of counter electrodes wherein either a shield potential or an excitation potential can be applied to each of the plurality of counter electrodes by the switching device and/or
the active surface of the sensor has a plurality of measuring electrodes, wherein a measuring potential can be applied to one of the plurality of measuring electrodes in each case by the measurement electronics, in particular alternately by activating the switching device by the measurement electronics, and the evaluation unit is set up to evaluate a respective first, second and third measuring signal detected by each of the plurality of measuring electrodes.

14. The sensor according to claim 9, wherein the sensor is designed, during proper operation of the sensor, to detect the measurement object in the case of an evaluated detected third measurement signal which is greater than the determined setting value and to output the third measurement signal in the form of a leakage measurement signal or a level measurement signal, by display device comprised by the sensor.

15. (canceled)

16. A measurement arrangement comprising a proximity sensor set up to perform the method according to claim 1, wherein the sensor comprises:
measurement electronics for generating a spatial measurement field and for detecting a measurement object within the measurement field with:
an active surface, which has at least one measuring electrode and at least one counter electrode, the measuring field extending essentially transversely to the active surface and starting from the active surface, and
an evaluation unit for evaluating a measurement signal detected by the at least one measuring electrode,
wherein the sensor can be attached to a surface of a measurement arrangement, for measuring in a measuring position in which a component of the measurement arrangement is located within the measuring field of the sensor,
wherein a calibration value can be stored or is stored in the measurement electronics, the calibration value being based on a first measurement signal which has been detected in a state of the sensor which is not in the measuring position, and a setting value can also be stored or is stored in the measurement electronics, the setting value being based on a second measurement signal which has been detected in a state of the sensor which is in the measuring position when the measurement object is missing within the measurement field,
wherein an adjustment value is greater than the calibration value,
the measurement electronics being set up to specify a threshold value in such a way that the threshold value is defined by a value lying between the calibration value and the setting value, and
the sensor being set up to start a measurement process for detecting the measurement object within the measurement field when the sensor is in the measuring position and to capacitively detect and evaluate a third measurement signal by the measurement electronics, and in the event that the detected third measurement signal evaluated by the measurement electronics corresponds to a measurement value which is less than the defined threshold value or equal to the defined threshold value, to output a warning signal.
